(19) United States
(12) Patent Application Publication
(10) Pub. No.: US 2007/0060671 A1
(43) Pub. Date: Mar. 15, 2007

(54) Polyolefin magnetic fine particle having functional group on the surface thereof

(75) Inventors: Yuzuru Sugano, Kanagawa (JP); Kenzo Susa, Tokyo (JP); Kenji Arimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: TRIAL CORPORATION Precision System Science Co., Ltd.

(21) Appl. No.: 10/576,269

(22) PCT Filed: Oct. 27, 2004
(86) PCT No.: PCT/JP04/15887

§ 371 Date: Apr. 18, 2006

(30) Foreign Application Priority Data
Oct. 31, 2003 (JP) 2003-373357

(51) Int. Cl. C09D 151/00; C08K 3/10

(52) U.S. Cl. 523/201; 524/434

(57) ABSTRACT

The present invention relates to fine particles in which desired magnetic particles are enclosed, the fine particles being easy to handle, having a large surface area, being resistant to settling, being compact, and having a functional group such as a carboxyl group on the particle surface. The fine particles include at least one type of polyolefin or polyolefin copolymer and at least one type of magnetic material, are substantially spherical particles having a density of 0.9 to 1.5 g/cc and an average particle size of 0.5 μm to 1,000 μm, and have a functional group on the particle surface.

### TECHNICAL FIELD

The present invention relates to magnetic fine particles and, more particularly, to magnetic fine particles having a functional group such as a carboxyl group on the surface of the particles.

### BACKGROUND ART

Conventionally, fine particles in which magnetic particles have been enclosed are produced by dispersing in a polymerizable monomer magnetic particles that have been subjected to a lipophilization treatment, and polymerizing by a suspension polymerization method (e.g. Patent Publication 1), an emulsion polymerization method (e.g. Patent Publication 2), etc. Furthermore, a method for incorporating a useful carboxyl group onto the surface of particles has been disclosed (Patent Publication 3). However, since all of these methods employ a polymerizable monomer as a starting material, the magnetic particles that are added inhibit the polymerization reaction. Because of this, the magnetic particle content is often restricted, and the particle size of the resulting magnetic fine particles is often as small as approximately 1 μm or less. There is therefore a desire for the efficient production of magnetic fine particles that, regardless of the magnetic particle content, have a particle size that is equal to or greater than 1 μm, and preferably equal to or greater than 5 μm, which are easy to handle, and have a large surface area. Furthermore, these particles are just in a state in which the monomer is polymerized, have lower compactness compared with fine particles melt-molded using a thermoplastic resin, etc., and are easily permeated by a solvent in a strongly acidic or strongly alkaline dispersion medium. Many thereof are formed by polymerization of styrene or a styrene derivative as the type of resin used, and the density is greater than 1 even in a state in which magnetic particles are not enclosed therein. Therefore, the fine particles in which magnetic particles are enclosed are heavier, and when used in an aqueous dispersion medium, there is often the problem that they easily settle. In particular, for those having a particle size equal to or greater than 5 μm settling easily occurs.

With regard to the above, the present inventors have developed a method (melt phase separation method) for efficiently producing substantially spherical fine particles of 0.1 to 1,000 μm, and preferably 5 to 500 μm, by melting two types of mutually incompatible thermoplastic resins so as to separate phases in a sea-island structure (Patent Publication 4), which has enabled fine particles comprising various thermoplastic resins to be produced. Furthermore, based on this method, a method for producing composite fine particles in which inorganic material such as magnetic particles is enclosed in the above fine particles has been developed (Patent Publication 5). However, the surface of these fine particles merely reflects the characteristics of the starting resin, and there are not a lot of useful functional groups on the surface.

Patent Publication 1: JP-A-59-221302 (JP-A denotes a Japanese unexamined patent application publication.)

Patent Publication 2: JP-B-3-57921 (JP-B denotes a Japanese examined patent application publication.)

Patent Publication 3: JP-A-10-87711

Patent Publication 4: JP-A-61-9433

Patent Publication 5: JP-A-2001-114901

### DISCLOSURE OF INVENTION

### PROBLEMS TO BE SOLVED BY THE INVENTION

It is an object of the present invention to provide fine particles in which desired magnetic particles are enclosed, the fine particles being easy to handle, having a large surface area, being resistant to settling, being compact, and having a functional group such as a carboxyl group on the particle surface.

### MEANS FOR SOLVING THE PROBLEMS

The object of the present invention has been accomplished by the invention of Item 1. Item 1 is described below together with Item 2 to Item 10, which are preferred embodiments thereof.

Item 1) Fine particles comprising at least one type of polyolefin or polyolefin copolymer and at least one type of magnetic material, the fine particles being substantially spherical particles having a density of 0.9 to 1.5 g/cc and an average particle size of 0.5 μm to 1000 μm, and the fine particles having a functional group on the particle surface,

Item 2) the fine particles according to Item 1, wherein the polyolefin is polypropylene and/or polyethylene, and the polyolefin copolymer is a propylene copolymer and/or an ethylene copolymer,

Item 3) the fine particles according to Item 1 or 2, wherein the functional group is at least one type selected from the group consisting of a carboxyl group, an amino group, a hydroxyl group, a sulfonic acid group, and a glycidyl group,

Item 4) the fine particles according to Item 3, wherein the functional group is (1) a functional group in a graft polymer formed by subjecting particles to surface graft polymerization, (2) a functional group bonded to an aliphatic hydrocarbon that has been kneaded with the particles and is present on the particle surface, or (3) a functional group in a monomer copolymerized into a main chain of the polyolefin copolymer,

Item 5) the fine particles according to any one of Items 1 to 4, wherein the average particle size is 1.0 μm to 100 μm,

Item 6) the fine particles according to any one of Items 1 to 5, wherein the density is 1.0 to 1.1 g/cc,

Item 7) the fine particles according to any one of Items 1 to 6, wherein the magnetic material is a soft magnetic material,

Item 8) the fine particles according to any one of Items 1 to 7, wherein the magnetic material is a superparamagnetic substance,

Item 9) the fine particles according to Item 7, wherein the soft magnetic material is a manganese-zinc ferrite and/or a nickel-zinc ferrite, and Item 10) the fine particles according to any one of Items 1 to 9, wherein the content of the magnetic material is 10 to 25 wt % relative to the total weight of the fine particles.

### EFFECTS OF THE INVENTION

In accordance with the present invention, fine particles that are resistant to settling and have on the surface a highly chemically reactive functional group are obtained.

### BEST MODE FOR CARRYING OUT THE INVENTION

The fine particles of the present invention comprise at least one type of polyolefin or polyolefin copolymer and at least one type of magnetic material, the fine particles being substantially spherical particles having a density of 0.9 to 1.5 g/cc and an average particle size of 0.5 μm to 1,000 μm, and the fine particles having a functional group on the particle surface.

The ‘functional group’ referred to in the present invention means an atom or an atomic group that is present in a molecule of a polymer, a copolymer, or an organic compound and causes reactivity characteristic of the compound. The ‘substantially spherical’ referred to here means that the ratio of three orthogonal axes of the particles is equal to or less than 2. The fine particles of the present invention are preferably true spheres. The ‘true spheres’ referred to here means that the ratio of three orthogonal axes of the particles is 0.9 to 1.1. In the present invention, the ‘particle size’ referred to means particle diameter. Furthermore, the ‘average particle size’ referred to here means a number-average particle diameter.

The fine particles of the present invention are explained in detail below.

Resin Material

In accordance with the present invention, as a material for the fine particles enclosing a magnetic material, a polyolefin is preferable. Since the density of a polyolefin is as low as 0.83 to 0.95, the overall density of the particles can be made relatively low even after magnetic particles are added. As the polyolefin, polypropylene, polyethylene, polymethylpentene, poly(1-butene), polyisobutylene, etc. are preferable, polypropylene and polyethylene are more preferable, and polypropylene is particularly preferable. These polyolefins may be used singly or in a combination of two or more types.

As a resin material, a polyolefin or a polyolefin copolymer may be used. Examples of the polyolefin copolymer include a copolymer of two or more types of olefin monomers and a copolymer of an olefin monomer and a monomer having a functional group.

As the olefin monomer, ethylene, propylene, methylpentene, 1-butene, isobutylene, etc. are preferable, and ethylene and propylene are more preferable.

As a monomer other than the olefin monomer, an ethylenically unsaturated compound having a functional group (carboxyl group) (also called a ‘monomer having a functional group’) such as acrylic acid and an ethylenically unsaturated compound such as vinyl acetate that can be converted into a functional group such as a hydroxyl group by a chemical treatment such as alkaline hydrolysis, etc. are preferable. The monomer having a functional group is explained in detail later.

Examples of the copolymer of two or more types of olefin monomers include an ethylene-propylene copolymer. Examples of the copolymer of an olefin monomer and a monomer other than an olefin monomer include an ethylene-acrylic acid copolymer and an ethylene-vinyl acetate copolymer.

The fine particles of the present invention preferably contain no resin other than the polyolefin and/or the polyolefin copolymer as the resin material.

Fine Particle Surface Functional Group

As the functional group present on the surface of the fine particles, at least one type selected from the group consisting of a carboxyl group, an amino group, a hydroxyl group, a sulfonic acid group, and a glycidyl group is preferable, and a carboxyl group and an amino group are particularly preferable. These functional groups may be selected according to the intended purpose of the fine particles.

Incorporation of Functional Group

(1) to (3) described in Item 4) above are explained in detail one by one.

As means for introducing a functional group, various methods may be employed. As one method, after polyolefin fine particles in which magnetic particles are enclosed are produced by employing the melt phase separation method developed by the present inventors, a surface graft polymerization method is employed. The surface graft polymerization method is a method known to a person skilled in the art, and a monomer having a desired functional group is graft-polymerized onto the particle surface via polymerization initiation sites formed on the particle surface. The polymerization initiation sites may be formed by irradiating the fine particles in the presence of a monomer with γ-rays, etc. Alternatively, after the polymerization initiation sites are formed in advance on the fine particle surface by electron beam irradiation, etc., the particles may be contacted with a monomer so as to grow a graft chain.

The monomer content used in the graft polymerization is preferably 1 to 30 wt % relative to the polyolefin fine particles in which magnetic particles are enclosed.

Examples of the monomer having a functional group include unsaturated carboxylic acids such as acrylic acid, itaconic acid, fumaric acid, crotonic acid, and maleic anhydride, glycidyl acrylate, glycidyl methacrylate, 2-hydroxyethyl acrylate, 2-hydroxyethyl methacrylate, 2-hydroxypropyl acrylate, 2-hydroxypropyl methacrylate, hydroxyethyl vinyl ether, vinyl sulfonic acid, and sulfonic acid-containing conjugated diene type monomers (1,3-butadiene, etc.).

As a method for incorporating a functional group into the fine particle surface, after fine particles are formed using a polyolefin copolymer from copolymerization of an unsaturated carboxylic acid ester such as ethyl (meth)acrylate, a carboxyl group may be formed on the particle surface by alkaline hydrolysis.

As another method for incorporating a functional group into the particle surface, the same melt phase separation method is employed, and by kneading a polyolefin or a polyolefin copolymer with an aliphatic hydrocarbon (preferably a saturated paraffin; a functional group-bonded aliphatic hydrocarbon) having a desired functional group preferably at the terminus of the molecule and separating phases, a desired functional group can be incorporated into the particle surface. As the functional group-bonded aliphatic hydrocarbon, a higher fatty acid, a fatty alcohol, a higher aliphatic amine, various types of metal soap, etc. having 16 to 22 carbons (C) are preferably used.

Preferred examples of the higher fatty acid include stearic acid, palmitic acid, oleic acid, linoleic acid, linolenic acid, and behenic acid.

Preferred examples of the fatty alcohol include stearyl alcohol, oleyl alcohol, octadecanyl alcohol, and nonadecanyl alcohol.

Preferred examples of the higher aliphatic amine include octadecylamine, (Z,Z)-9,12-octadecadienylamine, and oleylamine.

With regard to the aliphatic hydrocarbon having a functional group at the terminus, which is added to the polyolefin (copolymer), in the melt phase separation process its hydrocarbon chain moiety coexists with the polyolefin in a compatible manner, but since the terminal functional group, such as a carboxyl group, is attracted toward a phase-separated sea component (hydrophilic), the desired structure is realized.

The content of the functional group-bonded aliphatic hydrocarbon that is mixed and melted in the polyolefin is preferably 1 to 10 wt % relative to the polyolefin.

With regard to yet another method for incorporating a functional group into the particle surface, by employing the melt phase separation method and using, as a polymer that is subjected to melt phase separation, a copolymer (including a graft polymer) of an olefin and a monomer having a desired functional group, a polymer having the desired functional group can be made to be present on the outside of the polyolefin particles in which magnetic particles are enclosed.

Preferred examples of the monomer (monomer) having a functional group include unsaturated carboxylic acids such as acrylic acid, itaconic acid, fumaric acid, crotonic acid, and maleic anhydride, glycidyl group-containing monomers such as glycidyl acrylate and glycidyl methacrylate, hydroxyl group-containing monomers such as 2-hydroxyethyl acrylate, 2-hydroxyethyl methacrylate, 2-hydroxypropyl acrylate, 2-hydroxypropyl methacrylate, and hydroxyethyl vinyl ether, vinylsulfonic acid, and sulfonic acid-containing conjugated diene type monomers.

As a polymer having a functional group, a polyolefin copolymer having the above-mentioned monomer as a copolymer component can be used.

The amount of monomer having a functional group that is copolymerized (including a graft copolymer) with the olefin is preferably 1 to 30 wt % relative to the polyolefin.

As the olefin, propylene, ethylene, methylpentene, 1-butene, isobutylene, etc. are preferable, propylene and ethylene are more preferable, and ethylene is particularly preferable.

Specific examples of the polyolefin formed by copolymerization of a functional group-containing monomer include polyethylene copolymerized with 1 to 20 wt % of acrylic acid.

The functional group on the fine particle surface may be converted into another functional group by organic chemical means, preferably after the fine particles are formed. For example, reducing a carboxyl group with a reducing agent such as lithium aluminum hydride gives a hydroxyl group. Oxidizing a hydroxyl group with an oxidizing agent such as a sulfur trioxide-pyridine complex gives a formyl group. Furthermore, a formyl group may be converted into an amino group by a reductive amination reaction.

The average particle size of the fine particles of the present invention is 0.5 μm to 1,000 μm, preferably 1.0 μm to 200 μm, more preferably 1.0 μm to 100 μm, yet more preferably 10 μm to 100 μm, and particularly preferably 20 μm to 50 μm.

The particle size distribution of the fine particles of the present invention may be monodisperse or polydisperse, but it is preferably monodisperse, in which the particle size is uniform. By applying a wet classification method or a dry classification method to fine particles having a polydisperse particle size dispersion, fine particles having a desired average particle size may be obtained.

The density of the fine particles of the present invention is preferably 0.9 to 1.5 g/cc, and more preferably 1.0 to 1.1 g/cc. If the density is in the above-mentioned range, the fine particles are resistant to settling in an aqueous dispersion medium.

The surface area per particle of the fine particles of the present invention is preferably 7.5×10⁻¹³ to 3×10⁻⁶ m², more preferably 3×10⁻¹⁰ to 3×8⁻⁸ m², and yet more preferably 6×10⁻¹⁰ to 7.5×10⁻⁹ m².

Magnetic Particles

With regard to magnetic particles that can be used in the present invention, any particles may be used as long as they are smaller than the size of target fine particles. One of the purposes for enclosing the magnetic particles in the fine particles is to drive the fine particles in a very small region under various chemical environments by means of an external magnetic field so as to carry out a unit operation such as dispersion, separation, collection, stirring, mixing, flow rate control, or valve operation. With regard to magnetic particles used for this purpose, it is preferable to use a ferromagnetic material having spontaneous magnetization. The ferromagnetic material referred to here means a magnetic material having spontaneous magnetization such as ferromagnetism or ferrimagnetism. Such materials are diverse, and include metals, alloys, intermetallic compounds, oxides, and metal compounds. Furthermore, depending on the mode of use of the magnetic fine particles of the present invention, a magnetic material having low residual magnetization may be required. For such an application, a magnetic material exhibiting soft magnetism is generally suitable. Moreover, it is more preferable to use a superparamagnetic material, which is formed by making a ferromagnetic material at a nano-order size. The size of superparamagnetic particles is preferably 5 to 100 nm, and more preferably 10 to 50 nm.

The amount of magnetic particles packed depends on the polyolefin polymer used and the density or spontaneous magnetization of the magnetic material, but it is preferably 1 to 50 wt % relative to the total weight of the fine particles, more preferably 10 to 25 wt %, and particularly preferably 10 to 15 wt %.

As the metal material, the transition metals Fe, Ni, and Co are representative, and as alloys with these metals, Fe—V, Fe—Cr, Fe—Ni, Fe—Co, Ni—Co, Ni—Cu, Ni—Zn, Ni—V, Ni—Cr, Ni—Mn, Co—Cr, Co—Mn, 50Ni50Co—V, 50Ni50Co—Cr, etc. systems may be used. Among these, materials containing Fe or Ni, which have a large saturation magnetic moment, are preferable, and a Fe—Ni material is particularly preferable. When a material having a large saturation magnetic moment is used, the above-mentioned object can be attained with a small amount thereof packed, and fine particles having the density defined by the present invention can easily be obtained. As another metal material, the rare earth Gd, and alloys thereof, may be used.

Examples of the intermetallic compound include ZrFe₂, HfFe₂, FeBe₂ and, in addition, REFe₂ (RE=Sc, Y, Ce, Sn, Gd, Dy, Ho, Er, Tm), and GdCo₂. Examples thereof also include RECo₅ (RE=Y, La, Ce, Sm), Sm₂Co₁₇, Gd₂O₁₇ and, furthermore, Ni₃Mn, FeCa, FeNi, Ni₃Fe, CrPt₃, MnPt₃, FePd, FePd₃, Fe₃Pt, FePt, CoPt, CoPt₃, and Ni₃Pt.

As the oxide, a magnetic oxide having a crystal structure such as a spinel structure, a garnet structure, a perovskite structure, or a magnetoplumbite structure may be used.

Examples of the spinel structure include MFe₂O₄ (M=Mn, Fe, Co, Ni, Cu, Mg, Zn, Lio_{0.5}Feo_{0.5}), FeMn₂O₄, FeCo₂O₄, NiCo₂O₄, and γ-Fe₂O₃. γ-Fe₂O₃ is an iron oxide called maghemite. This is different from α-Fe₂O₃ (colcothar), which is known as a pigment, and is known as a material having a relatively low density (about 3.6 g/cc) and a large saturation magnetic moment, and is particularly preferable as a packing agent used in the present invention. These are all known as soft magnetic materials and, in particular, M=(Mn, Zn), (Ni, Zn), that is, manganese-zinc ferrite, nickel-zinc ferrite, etc. have little residual magnetization, and give good operating characteristics for collection and dispersion of the magnetic fine particles by means of a magnetic field.

As the oxide having the garnet structure, rare earth iron garnet may be used. It is known that, when expressed using the formula R₃Fe₅O₁₂, ferrimagnetism is exhibited for R=Y, Sm, Zn, Gd, Tb, Dy, Ho, Er, Tm, Yb, and Lu. Among these, Y, Sm, Yb, or Lu is preferable since the saturation magnetization is large. In particular, Y is preferable since its density is low (5.17 g/cc).

Examples of the oxide having the magnetoplumbite structure include MF₁₂O₁₉ (M =Ba, Sr, Ca, Pb, Ag_{0.5}La_{0.5}, Ni_{0.5}La_{0.5}), M₂BaFe₁₆O₂₇ (M=Mn, Fe, Ni, Fe_{0.5}Zn_{0.5}, Mn_{0.5}Zn_{0.5}), M₂Ba₃Fe₂₄O₄₁ (M=Co, Ni, Cu, Mg, Co_{0.75}Fe_{0.25}), and M₂Ba₂Fe₁₂O₂₂ (M=Mn, Co, Ni, Mg, Zn, Fe_{0.25}Zn_{0.75}).

Examples of the oxide having the perovskite structure include RFeO₃ (R=rare earth ion).

As the metal compound, a boride (Co₃B, CoB, Fe₃B, MnB, FeB, etc.), an Al compound (Fe₃Al, Cu₂MnAl, etc.), a carbide (Fe₃C, Fe₂C, Mn₃ZnC, CO₂Mn₂C, etc.), a silicide (Fe₃Si, Fe₅Si₃, Co₂MnSi, etc.), a nitride (Mn₄N, Fe₄N, Fe₈N, Fe₃NiN, F₃PtN, Fe₂N_{0.75}, Mn₄N_{0.75}Co_{0.25}, Mn₄NO_{0.5}C_{0.5}, Fe₄N₁₋ₓCₓ, etc.) and, in addition, a phosphide, an arsenic compound, an Sb compound, a Bi compound, a sulfide, an Se compound, a Te compound, a halogen compound, a rare earth element, etc. may be used.

Other magnetic materials are described in S. Chikazumi ‘Kyoujiseitai no Butsuri’ (Physics of Ferromagnetic Substances), Shokabo Publishing (April 1983, 4th Edition).

As the superparamagnetic substance, any substance may be used as long as it is a ferromagnetic material having a particle size of a few nm to a few tens of nm. In particular, nano particles of magnetite, etc. are preferable. Specifically, nano particles of 5 to 100 nm are preferably used, and nano particles of 10 to 50 nm are more preferably used.

As examples of applications of the fine particles of the present invention there can be cited diagnostic agent carriers, cell separation carriers, cell culture carriers, nucleic acid separation/purification carriers, protein separation/purification carriers, immobilized enzyme carriers, immobilized catalyst carriers, drug delivery carriers, reaction media in a micro flow path, magnetic toners, magnetic inks, and magnetic paints.

### Examples

Examples are shown below, but the present invention should not be construed as being limited to these Examples. Evaluation of magnetic fine particles having a surface functional group in the Examples below was carried out by the following methods.

Particle Size

An optical microscope photograph of a fine particle sample was taken, a 1 mm square grid was superimposed thereon, 100 to 150 particles were randomly extracted and measured, and a particle size range that included 90% thereof was determined.

Density

After a fine particle sample was dried, measurement was carried out ten times using a helium displacement pycnometer, and an average value of the last three measurement values was defined as the density of the sample.

Identification of Resin and Functional Group on the Fine Particle Surface

After a fine particle sample was dried, identification of a resin was carried out by measurement of a diffuse reflection infrared absorption spectrum. The presence or absence of a surface functional group was judged from the above spectrum.

Magnetic Responsiveness

0.1 g of a fine particle sample was dispersed in 5 cc of water in a 10 cc plastic container, and the magnetic responsiveness was defined as good if the magnetic resin particles were drawn toward the container wall within a few seconds when a magnetic field (about 50 kA/m) was applied from the outside of the container using a permanent magnet, and the particles dispersed to the original state without aggregating when the magnet was removed.

### Example 1

To 850 g of polypropylene having a density of 0.91, manganese-zinc ferrite particles (particle size: 0.13 μm) that had previously been subjected to a lipophilization treatment were added at 5, 10, 15, 20, 25, 30, and 50 wt % relative to the total weight of the finally obtained fine particles, they were further mixed using a twin shaft pressure kneader using 1.5 kg of polyethylene glycol (P20000:P10000=1:1 mixture, manufactured by Sanyo Chemical Industries, Ltd.) as a dispersing medium while heating at 190° C., and the mixture was charged into water, which is a developing solvent. Manganese-zinc ferrite-containing polypropylene fine particles were obtained by this melt phase separation method.

Subsequently, the particle surface was subjected to surface graft polymerization with about 10 wt % of acrylic acid. Following this, classification was carried out using wet sieving, and the fine particles so obtained were evaluated in terms of particle size, specific gravity, identification of resin, the presence or absence of a functional group, and magnetic responsiveness. The same evaluation was carried out by preparing fine particles having different particle sizes under various production conditions for the case in which the magnetic particle content was 20 wt %. These results are given in Table 1. As a comparative example, fine particles that had not been subjected to graft polymerization were evaluated, and are shown in the same table.

TABLE 1

| Magnetic | | | | | |
|---|---|---|---|---|---|
| particle | Particle size | Density | | Functional | Magnetic |
| content (Wt %) | (μm) | (g/cc) | Resin | group present | responsiveness |
| 5 | 35 to 45 | 0.94 | PP | Yes | Slightly weak, |
| | | | | | sometimes rises to |
| | | | | | surface |
| 10 | 35 to 45 | 0.99 | PP | Yes | Slightly weak, |
| | | | | | sometimes rises to |
| | | | | | surface |
| 15 | 35 to 45 | 1.03 | PP | Yes | Good |
| 20 | 10 to 20 | 1.08 | PP | Yes | Good |
| 20 | 35 to 45 | 1.08 | PP | Yes | Good |
| 20 | 50 to 100 | 1.08 | PP | Yes | Good |
| 20 | 150 to 200 | 1.08 | PP | Yes | Good |
| 25 | 35 to 45 | 1.10 | PP | Yes | Good |
| 30 | 35 to 45 | 1.20 | PP | Yes | Good, settles slightly |
| | | | | | easily |
| 50 | 35 to 45 | 1.50 | PP | Yes | Good, settles slightly |
| | | | | | easily |
| 20 | 35 to 45 | 1.08 | PP | No | Good |
| (Comp. Ex.) | | | | | |

PP: polypropylene

It was found from the Example above that the object of the present invention was satisfied in all cases, but when the density was 1.03 to 1.10 g/cc, good magnetic responsiveness was achieved.

### Example 2

The procedure of Example 1 was repeated except that instead of carrying out graft polymerization, stearic acid was added to the polypropylene starting material at a weight of 1%, 5%, and 10%, and magnetic particle-containing fine particles were prepared in the same manner by the melt phase separation method using a composition containing manganese-zinc ferrite at 17 wt %. From the evaluation results, the particle size was 10 to 50 μm in all cases, and the density was 1.03 to 1.06 g/cc. Furthermore, it was found that the fine particles contained polypropylene as the main component and had a carboxyl group as the functional group on the particle surface, and the magnetic responsiveness was good.

### Example 3

The procedure of Example 1 was repeated except that instead of carrying out graft polymerization as a post-treatment, polypropylene was replaced by an ethylene acrylic acid copolymer (acrylic acid 8%) (Nucrel N1108, manufactured by Mitsui Dupont Polychemicals Co., Ltd.), and magnetic particle-containing fine particles were prepared in the same manner by the melt phase separation method using a composition containing manganese-zinc ferrite at 15 wt %. From the evaluation results, the particle size was 10 to 50 μm, and the density was 1.07 g/cc. Furthermore, it was found that the fine particles contained polyethylene as the main component and had a carboxyl group as the functional group on the particle surface, and the magnetic responsiveness was good.

### Example 4

Magnetic particle-containing fine particles were prepared in the same manner as in Example 1 except that instead of manganese-zinc ferrite, various magnetic materials were added at 17%. The evaluation results are given in Table 2.

TABLE 2

| | Magnetic | | | | |
|---|---|---|---|---|---|
| Magnetic | resin particle | | Resin | Functional | Magnetic |
| material | size | Density | identi- | group | respon- |
| (particle size) | (μm) | (g/cc) | fication | present | siveness |
| Fe₃O₄ | 35 to 45 | 1.05 | PP | Yes | Good |
| (10 nm) | | | | | |
| γ-Fe₂O₃ | 35 to 45 | 1.04 | PP | Yes | Good |
| (0.14 μm) | | | | | |
| (NiZn)Fe₂O₄ | 35 to 45 | 1.06 | PP | Yes | Good |
| (1.0 μm) | | | | | |
| Iron | 35 to 45 | 1.08 | PP | Yes | Good |
| (1-2 μm) | | | | | |

PP: polypropylene

### Example 5

Fine particles were prepared under the same conditions as in Example 2 except that, instead of stearic acid, octadecylamine was used. From the evaluation results, the particle size was 10 to 50 μm, and the density was 1.03 to 1.06 g/cc. Furthermore, it was found that the fine particles contained polypropylene as the main component and had an amino group as the functional group on the particle surface, and the magnetic responsiveness was good.

1. Fine particles, comprising:
at least one polymer selected from the group consisting of a polyolefin and a polyolefin copolymer; and
at least one magnetic material,
wherein the particles are substantially spherical particles having a density of 0.9 to 1.5 g/cc and an average particle size of 0.5 μm to 1,000 μm,
the particles have a functional group on the particle surface.

2. The fine particles according to claim 1, wherein the polyolefin is selected from the group consisting of a polypropylene, a polyethylene, and mixtures thereof, and the polyolefin copolymer is selected from the group consisting of a propylene copolymer, and/or an ethylene copolymer, and mixtures thereof.

3. The fine particles according to either claim 1 or 2, wherein the functional group is at least one group selected from the group consisting of a carboxyl group, an amino group, a hydroxyl group, a sulfonic acid group, and a glycidyl group.

4. The fine particles according to claim 3, wherein the functional group is selected from the group consisting of;
(1) a functional group in a graft polymer formed by subjecting particles to surface graft polymerization,
(2) a functional group bonded to an aliphatic hydrocarbon that is present on the particle surface; and
(3) a functional group in a comonomeric unit copolymerized into the polyolefin copolymer.

5. The fine particles according to any one of claims 1 to 2, wherein the average particle size is 1.0 μm to 100 μm.

6. The fine particles according to any one of claims 1 to 2, wherein the density is 1.0 to 1.1 g/cc.

7. The fine particles according to any one of claims 1 to 2, wherein the magnetic material is a soft magnetic material.

8. The fine particles according to any one of claims 1 to 2, wherein the magnetic material is a superparamagnetic substance.

9. The fine particles according to claim 7, wherein the soft magnetic material is selected from the group consisting of a manganese-zinc ferrite, a nickel-zinc ferrite, and a mixture thereof.

10. The fine particles according to any one of claims 1 to 9, wherein the content of the magnetic material is 10 to 25 wt % relative to the total weight of the fine particles.
